(19) United States
(12) Patent Application Publication
(10) Pub. No.: US 2004/0207608 A1
(43) Pub. Date: Oct. 21, 2004

(54) Picture frame layer for displays without using any additional display memory

(76) Inventor: Ricardo Te Lim, Richmond (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/414,971

(22) Filed: Apr. 16, 2003

(51) Int. Cl. G09G 5/00

(52) U.S. Cl. 345/204

(57) ABSTRACT

A picture frame for a display is provided without using any additional display memory. A multiplexer is provided between the display controller output and the display device. There are twelve programmable values which are utilized to control the multiplexer. These twelve parameters are stored in registers in the display controller. The loading of these registers allows a picture frame of any size to be placed on the LCD panel. The color and attributes of the desired picture frame can be modified to meet any display requirements.

### BACKGROUND OF THE INVENTION

1. Field of the Invention

This invention relates to a method for a picture frame for a display without using any additional display memory.

More particularly this invention relates to providing a display picture frame by inserting a multiplexer between the display controller output and the display device.

2. Description of the Related Art

FIG. 1 shows a block diagram of the prior art. A liquid crystal display controller 110 has the pixel data 120 as output. Typically, an LCD controller has address and data bus inputs that provide display controller instructions and display parameter information to be loaded into registers. These display parameters control many aspects of the LCD display.

U.S. Pat. No. 5,850,216 (Kwon) “Driver Circuit for Thin Film Transistor-Liquid Crystal Display” describes a thin-film transistor driver circuit. A multiplexer is used to select count signals from a ripple counter corresponding to a scanning direction.

U.S. Pat. No. 5,621,433 (Acksteiner) “Low-Cost Multichannel Oscilloscope for Teaching and Demonstration Purposes” describes a multi-channel oscilloscope. A multiplexer is used to receive data from a plurality of channels for display on an LCD panel.

### OBJECTS OF THE INVENTION

It is an object of this invention to provide a method for a displaying a picture frame for a display without using any additional display memory.

It is further an object of this invention to provide a display picture frame by inserting a multiplexer between the display controller output and the display device.

### SUMMARY OF THE INVENTION

The objects of this invention are achieved by a method of creating a creating a picture frame layer for displays without using any additional display memory comprising the steps of: providing a multiplexer at a pixel output bus of a display controller and inputting picture frame color data and pixel data to said multiplexer, defining picture frame position parameters which describe boundaries of a desired picture frame, defining picture frame color control parameters which control the display of the desired picture frame, providing storage registers that are loaded with said picture frame position parameters, providing storage registers that are loaded with said picture frame color control parameters, comparing said picture frame position parameters in said storage registers with a display memory refresh address, selecting picture frame color data from said multiplexer when said picture frame position parameters match said display memory refresh address, and modifying said selection in accordance with picture frame color control parameter values stored in said storage registers.

The objects of this invention are also achieved by a device for creating a picture frame layer for displays without using any additional display memory comprising: a multiplexer at a pixel output bus of a display controller, said multiplexer having as inputs picture frame color data and pixel data; first storage registers that store picture frame position parameters; second storage registers that store picture frame color control parameters; compare/control logic that compares said picture frame position parameters in said first storage registers with a display memory refresh address and that outputs multiplexer select signals; said multiplexer being responsive to said compare/control logic multiplexer select signals to select picture frame color data when said picture frame position parameters match said display memory refresh address, and said compare/control logic being responsive to said picture frame color control parameter values stored in said second storage registers for modifying said multiplexer select signals. The multiplexer comprises a plurality of selectable inputs including pixel data, picture frame background color data, picture frame border color data and picture frame color data. The picture frame color control parameters include a transparent background color control bit that determines whether said picture frame background color data or said pixel data is displayed outside of the picture frame; a Picfill color control bit that determines whether said picture frame background color data or said pixel data is displayed inside the picture frame; and a transparent frame color control bit that determines whether said picture frame color data or said pixel data is displayed as the picture frame.

### BRIEF DESCRIPTION OF THE DRAWINGS

FIG. 1 is a block diagram of a typical display controller in the prior art.

FIG. 2 is a block diagram of part of the display controller of the present invention, showing the multiplexer in detail.

FIG. 3 shows a picture frame and its corresponding programmable display parameters required to implement this invention.

FIG. 4 is a block diagram of further aspects of the display controller of the present invention.

### DESCRIPTION OF THE PREFERRED EMBODIMENTS

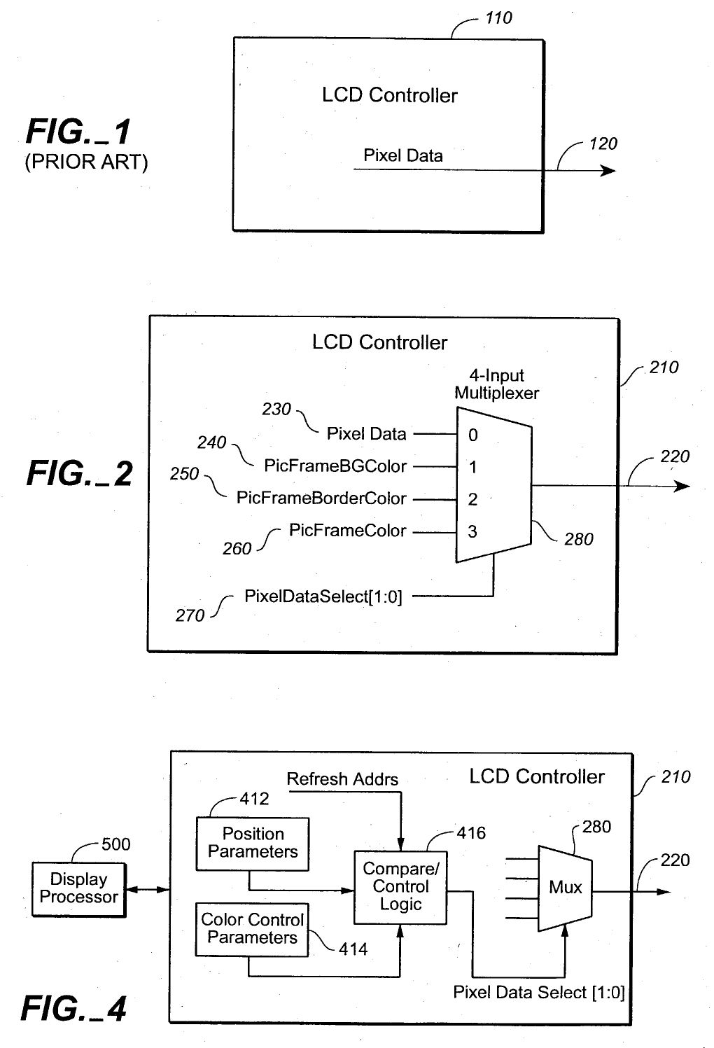

FIG. 2 shows a block diagram of the video multiplexer 280 of the liquid crystal display (LCD) controller 210 of the present invention. LCD controller 210 is preferably an integrated circuit (IC) device. This four input multiplexer receives as one input the Pixel Data that is normally output from the pixel output bus of a typical liquid crystal display (LCD) controller 110 that is shown in FIG. 1. FIG. 2 shows the four-input multiplexer inputs that include the above mentioned Pixel Data. The multiplexer has four data inputs and two control inputs. The actual implementation of the present invention may include 3, 4, or N of these multiplexers, one for each color plane. One possible implementation would include three color planes, Red, Green, & Blue (R,G,B). In this case there would be three multiplexers 280, one for each color plane R, G, or B.

The data inputs include the Pixel Data 230, which is the normal present art pixel output coming from the present art display controller. In addition, the next input is the Picture Frame Background Color PicFrameBGColor 240, which is used to display a background color at a given pixel location.

The next data input is the Picture Frame Border Color, PicFrameBorderColor250, which is used to display a frame border color at a given pixel location. The next input is the Picture Frame Color, PicFrameColor 260, which is used to display a picture frame color at a given pixel location. The values of 1's and 0's to be placed on the three multiplexer inputs in addition to the pixel data are determined by display processor 500 (FIG. 4) that interacts with the LCD Controller 210.

The display processor 500 that interacts with the LCD controller 210 determines the picture frame position parameters, which describe boundaries of a desired picture frame. Similarly, the display processor 500 that interacts with the LCD Controller 210 determines the picture frame color control parameters that control the display of a desired picture frame.

As shown in FIG. 4, storage registers 412 (Position Parameter Registers) are provided that store the current picture frame position parameters, and storage registers 414 (Color Control Parameter Registers) that store the current picture frame color control parameters. These registers are loaded from the display processor 500 during a display refresh operation.

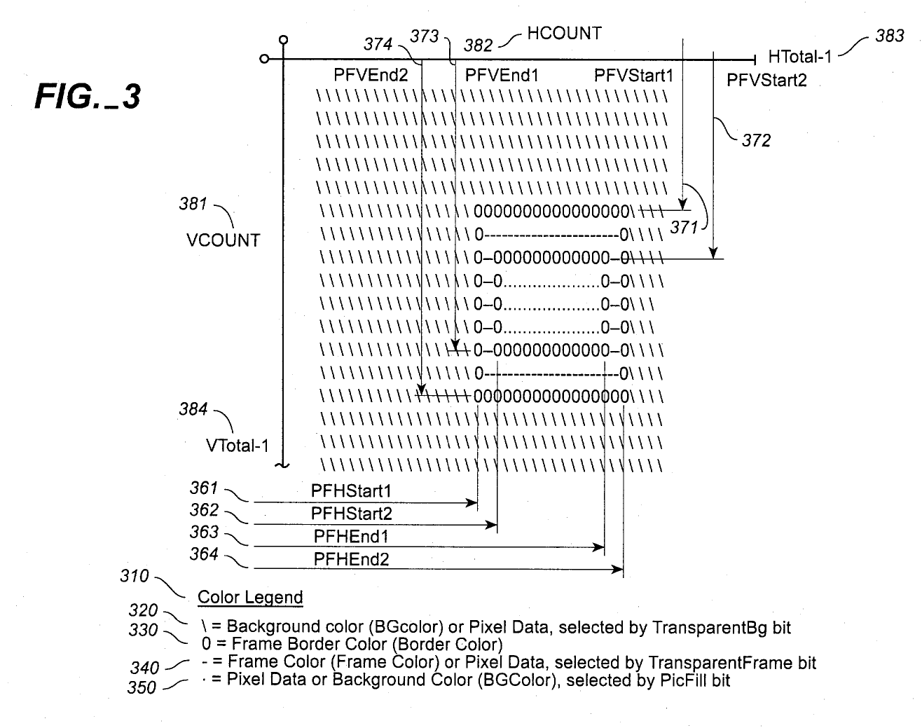

The picture frame position parameters (or address values that they represent) that are stored in registers 412 are fed into compare/control logic 416. The compare/control logic 416 can be implemented with discrete components, comparators, software, firmware or a combination thereof. The function of the picture frame position parameters is illustrated in FIG. 3, described hereinafter. They include picture frame horizontal start 1 (PFHStart1), picture frame horizontal start 2 (PFHStart2), picture frame horizontal end 1 (PFHEnd1) and picture frame horizontal end 2 (PFHEnd2). There are four similar parameters for the vertical start and stop for the picture frame. In addition, there are parameters for horizontal total (Htotal) and vertical total pixels (Vtotal). The above picture frame position parameters (or address values that they represent) are compared to the display address currently being refreshed (REFRESH ADDRS). The outputs of the compare/control logic 416 are encoded to generate the two-bit Pixel Data Select bus shown in FIG. 2. The encoding is shown in the table below. In the table below there are 4 cases. When the 2-bit coding is 0, 0, the normal pixel data is displayed. However, the color control parameter register 414 (described hereinafter) is read to determine if the normal pixel data or the background color is selected for display. For example, as shown in FIG. 3 under “Color Legend,” the pixel data or the background color is selected for display inside the picture frame if the PicFill control bit in the color control parameter register 414 is inactive or active, respectively. Similarly, when the 2-bit coding is 0, 1, the picture frame background color is displayed in the background area. However, the color control parameter register 414 is read to determine if the picture frame background color data or the pixel data is selected for display. Similarly, when the 2-bit coding is 1,0 the picture frame border color is displayed. Similarly, when the 2-bit coding is 1,1, the picture frame color is displayed in the picture frame area. However, the color control parameter register 414 is read to determine if the picture frame color data or pixel data is selected for display.

The two control inputs, Pixel Data Select (1:0) 270 are encoded to select one of the above four data inputs 230, 240, 250, 260 to the multiplexer 280. A possible encoding of these two control bits is as follows.

| | Pixel Data Select | Pixel Data Select |
|---|---|---|
| Function | Bit 1 | Bit 0 |
| Pixel Data | 0 | 0 |
| PicFrameBGColor | 0 | 1 |
| PicFrameBorderColor | 1 | 0 |
| PicFrame Color | 1 | 1 |

In addition to the above four multiplexer data inputs 230, 240, 250, 260, there are three programmable control bits that are stored in one or more writeable registers 414 (FIG. 4). The three control bits are Transparent background bit, Transparent frame bit, and the PicFill bit. The transparent background bit is used by the compare/control logic 416 to select for display between the PicFrameBGColor 240 multiplexer input and the pixel data 230 multiplexer input. If the transparent background color control bit is active, the pixel data is displayed in the background area. If the Transparent background control bit is inactive, the PicFrameBGColor 240 multiplexer input is selected and displayed in the background area.

The second control bit is a transparent frame bit, which is used by the compare/control logic 416 to select for display between the PicFrameColor 260 multiplexer input and the pixel data 230 multiplexer input. If the Transparent Frame color control bit is active, the pixel data is displayed in the frame area of the display. If the Transparent Frame control bit is inactive, the video the PicFrameColor 260 multiplexer input is selected and displayed in the frame area.

The third control bit is the PicFill bit, which is used by the compare/control logic 416 to select for display between the PicFrameBackground Color 240 multiplexer input and the pixel data 230 multiplexer input for display inside the picture frame. If the PicFill control bit is active, the PicFrame background color is selected for display. If the PicFill control bit is inactive, the pixel data is selected for display inside the picture frame.

FIG. 3 shows the parameters needed to implement the picture frame layer of this invention. There are four horizontal parameters. The PFH Start 1-parameter 361 represents the address of the left most outside edge of the picture frame. The PFH Start 2-picture frame horizontal Start 2 parameter 362 represents the address of the left most inside edge of the picture frame.

The PFH End 1 parameter 363 represents the address of the right most inside edge of the picture frame. The PFH End 2-picture frame horizontal End 2 parameter 364 represents the address of the right most outside edge of the picture frame.

FIG. 3 also shows the four vertical parameters needed to implement the picture frame layer of this invention. The PFV Start 1, picture frame vertical Start 1 parameter 371 represents the address of the top most outside edge of the picture frame. The PFV Start 2 picture frame vertical Start 2 parameter 372 represents the address of the top most inside edge of the picture frame.

The PFV End 1, picture frame vertical end 1 parameter 373 represents the address of the bottom most inside edge of the picture frame. The PFV End 2, picture frame vertical end 2 parameter 374 represents the address of the bottom most outside edge of the picture frame.

The Vcount, vertical count parameter 381 shown in FIG. 3 is the vertical offset of the presently displayed pixel. The H Count, horizontal count, parameter 382 in FIG. 3 is the horizontal offset of the presently displayed pixel. The Htotal parameter 383 in FIG. 3 contains the maximum horizontal pixel address of the total horizontal pixels in the display. The VTOTAL parameter 384 in FIG. 3 contains the maximum vertical pixel address of the total vertical pixels in the display.

These twelve parameters are stored in programmable registers 412 (Position Parameters registers 412, FIG. 4). The loading of these registers allows a picture frame of any size to be displayed on the LCD. The color and attributes of the desired picture frame can be modified to meet any display requirements. The picture frame size, positions, color, thickness, transparency and general attributes can be modified by loading the above twelve programmable registers.

The advantage of this invention is that the method saves adding additional display memory for displaying a picture frame. Traditional display design would require a separate plane of display memory in order to superimpose the picture frame at the proper location of the display. This separate plane for a picture frame could double the size of display memory in the worst case.

The addition of the video output multiplexer and its corresponding control registers and circuitry allow the elimination of the need for additional display memory.

While this invention has been particularly shown and described with reference to the preferred embodiments thereof, it will be understood by those skilled in the art that various changes in form and details may be made without departing from the spirit and scope of this invention.

What is claimed is:

1. A method of creating a picture frame layer for displays without using any additional display memory comprising the steps of:
providing a multiplexer at a pixel output bus of a display controller and inputting picture frame color data and pixel data to said multiplexer,
defining picture frame position parameters which describe boundaries of a desired picture frame,
defining picture frame color control parameters which control the display of the desired picture frame,
providing storage registers that are loaded with said picture frame position parameters,
providing storage registers that are loaded with said picture frame color control parameters,
comparing said picture frame position parameters in said storage registers with a display memory refresh address,
selecting picture frame color data from said multiplexer when said picture frame position parameters match said display memory refresh address, and
modifying said selection in accordance with picture frame color control parameter values stored in said storage registers.

2. The method of creating a picture frame layer for displays of claim 1, further comprising selecting as an output of said multiplexer one of a plurality of inputs to said multiplexer, said plurality of inputs including pixel data, picture frame background color data, picture frame border color data and picture frame color data.

3. The method of creating a picture frame layer for displays of claim 1 further comprising controlling said selecting from said multiplexer with pixel data select bits generated in said step of comparing said picture frame position parameters in said storage registers with said display memory refresh address.

4. The method of creating a picture frame layer for displays of claim 2, further comprising selecting in accordance with picture frame color control parameter values said picture frame background color data or pixel data for display outside of the picture frame.

5. The method of creating a picture frame layer for displays of claim 4 wherein said picture frame color control parameters include a transparent background color control bit that determines whether said picture frame background color data or said pixel data is displayed outside of the picture frame.

6. The method of creating a picture frame layer for displays of claim 2, further comprising selecting in accordance with picture frame color control parameter values said picture frame background color data or pixel data for display inside of the picture frame.

7. The method of creating a picture frame layer for displays of claim 6 wherein said picture frame color control parameters include a Picfill color control bit that determines whether said picture frame background color data or said pixel data is displayed inside the picture frame.

8. The method of creating a picture frame layer for displays of claim 2 further comprising selecting in accordance with picture frame color control parameter values said picture frame color data or pixel data for display of the picture frame.

9. The method of creating a picture frame layer for displays of claim 8 wherein said picture frame color control parameters include a transparent frame color control bit that determines whether said picture frame color data or said pixel data is displayed as the picture frame.

10. The method of creating a picture frame layer for displays of claim 1 wherein said picture frame position parameters include a horizontal starting address #1 that delineates a left-most outside edge boundary of said picture frame relative to a predefined origin point.

11. The method of creating a picture frame layer for displays of claim 10 wherein said picture frame position parameters include a horizontal starting address #2 that delineates a left-most inside edge boundary of said picture frame relative to a predefined origin point.

12. The method of creating a picture frame layer for displays of claim 10 wherein said picture frame position parameters include a horizontal ending address #1 that delineates a right-most inside edge of said picture frame relative to a predefined origin point.

13. The method of creating a picture frame layer for displays of claim 12 wherein said picture frame position parameters include a horizontal ending address #2 that delineates a right-most outside edge boundary of said picture frame relative to a predefined origin point.

14. The method of creating a picture frame layer for displays of claim 1 wherein said picture frame position parameters include a vertical starting address #1 that delineates a top-most outside edge boundary of said picture frame relative to a predefined origin point.

15. The method of creating a picture frame layer for displays of claim 14 wherein said picture frame position parameters include a vertical starting address #2 that delineates a top-most inside edge boundary of said picture frame relative to a predefined origin point.

16. The method of creating a picture frame layer for displays of claim 14 wherein said picture frame position parameters include a vertical ending address #1 that delineates a bottom-most inside edge of said picture frame relative to a predefined origin point.

17. The method of creating a picture frame layer for displays of claim 16 wherein said picture frame position parameters include a vertical ending address #2 that delineates a bottom-most outside edge boundary of said picture frame relative to a predefined origin point.

18. The method of creating a picture frame layer for displays of claim 1 wherein said picture frame position parameters include a vertical count that defines a vertical position of any given pixel relative to a predefined origin point.

19. The method of creating a picture frame layer for displays of claim 1 wherein said picture frame position parameters include a horizontal count that defines a horizontal position of any given pixel relative to a predefined origin point.

20. The method of creating a picture frame layer for displays of claim 1 wherein said picture frame position parameters include a vertical total that defines a maximum vertical dimension of the display relative to a predefined origin point.

21. The method of creating a picture frame layer for displays of claim 1 wherein picture frame position parameters include a horizontal total that defines a maximum horizontal dimension of the display relative to a predefined origin point.

22. A device for creating a picture frame layer for displays without using any additional display memory comprising:
a multiplexer at a pixel output bus of a display controller, said multiplexer having as inputs picture frame color data and pixel data;
first storage registers that store picture frame position parameters;
second storage registers that store picture frame color control parameters;
compare/control logic that compares said picture frame position parameters in said first storage registers with a display memory refresh address and that outputs multiplexer select signals;
said multiplexer being responsive to said compare/control logic multiplexer select signals to select picture frame color data when said picture frame position parameters match said display memory refresh address, and
said compare/control logic being responsive to said picture frame color control parameter values stored in said second storage registers for modifying said multiplexer select signals.

23. The device for creating a picture frame layer as in claim 22 wherein said multiplexer comprises a plurality of selectable inputs including pixel data, picture frame background color data, picture frame border color data and picture frame color data.

24. The device for creating a picture frame layer for displays of claim 23 wherein said picture frame color control parameters include a transparent background color control bit that determines whether said picture frame background color data or said pixel data is displayed outside of the picture frame.

25. The device for creating a picture frame layer for displays of claim 23 wherein said picture frame color control parameters include a Picfill color control bit that determines whether said picture frame background color data or said pixel data is displayed inside the picture frame.

26. The device for creating a picture frame layer for displays of claim 23 wherein said picture frame color control parameters include a transparent frame color control bit that determines whether said picture frame color data or said pixel data is displayed as the picture frame.
